(19) United States
(12) Patent Application Publication
(10) Pub. No.: US 2018/0130084 A1
(43) Pub. Date: May 10, 2018

(54) Systems and Methods for Use in Informing Consumers Regarding Benefits in Connection With Payment Account Purchases

(71) Applicant: MASTERCARD INTERNATIONAL INCORPORATED, Purchase, NY (US)

(72) Inventors: Kiran Hatti, Chesterfield, MO (US); Kiran Shenoy, O'Fallon, MO (US); Faisal Iqbal Chaudhry, St. Louis, MO (US); Mandeep Singh Sandhu, O'Fallon, MO (US)

(21) Appl. No.: 15/343,559

(22) Filed: Nov. 4, 2016

(51) Int. Cl. G06Q 30/02

(52) U.S. Cl. CPC G06Q 30/0226

(57) ABSTRACT

Systems and methods are provided for use in notifying consumer of benefits associated with payment accounts, in connection with payment account transactions. One exemplary method includes initially identifying, at a computing device, a transaction to a payment account where the transaction involves a merchant. The method also includes accessing, by the computing device, a benefit data structure for the payment account and determining, by the computing device, whether a relevant benefit is included in the benefit data structure for the payment account. The method then includes transmitting, by the computing device, a notification to the consumer regarding the relevant benefit, in connection with the identified transaction, whereby the consumer is permitted to avoid purchasing a benefit product from the merchant, which is at least partially duplicative of the relevant benefit.

### FIELD

The present disclosure generally relates to systems and methods for use in informing consumers about benefits in connection with payment account transactions, and in particular, to systems and methods for use in identifying benefits associated with payment accounts and further notifying the consumers associated with the payment accounts about the benefits in connection with payment account transactions relating to the benefits.

### BACKGROUND

This section provides background information related to the present disclosure which is not necessarily prior art.

Payment accounts are known to be issued to consumers, and are further known to be used, by the consumers, to fund transactions for the purchase of products, such as, for example, goods and services, etc. The payment accounts are often associated with reward programs, which permit consumers to accumulate rewards (e.g., points, miles, etc.) based on purchases funded by the payment accounts. The consumers are then able to redeem the rewards for products, reimbursements, cash, etc. In addition to rewards, certain payment accounts are associated with benefits, which may be automatically associated with the consumers' purchases. For example, some payment accounts offer travel insurance for travel booked and funded through the payment accounts, etc. The benefits are often explained to consumers prior to application for the payment accounts, as a means of distinguishing the payment accounts from other payment accounts, or in connection with such application so that the consumers are informed of the benefits.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in informing consumers about certain benefits in connection with payment account transactions;

FIG. 2 is a block diagram of a computing device suitable for use in the exemplary system of FIG. 1; and

FIG. 3 is an exemplary method, which may be implemented in connection with the system of FIG. 1, for use in informing a consumer about one or more benefits in connection with a payment account transaction by the consumer; and

FIGS. 4-7 illustrate exemplary interfaces for providing notifications to a consumer regarding certain benefits in connection with a payment account transaction by the consumer, and suitable for use in the exemplary system of FIG. 1 and/or the exemplary method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment accounts are often used by consumers to fund purchases of products (e.g., goods, services, etc.). The payment accounts may be associated with reward programs and benefits. Typically, the consumers are informed of benefits associated with their payment accounts just prior to applying and/or when applying for the payment accounts, or potentially upon issuance of the payment accounts. Uniquely, the systems and methods herein permit the consumers to be further informed regarding such benefits in connection with payment account transactions involving the payment accounts (or other payment accounts). In particular, in connection with a payment account transaction by a consumer, a benefit engine accesses a benefit data structure to determine if one or more benefits, relevant to the transaction, is associated with the payment account to which the transaction is directed (or another payment account associated with the same consumer). If one or more benefits is identified, the benefit engine transmits a notification to the consumer, thereby permitting the consumer to avoid purchasing a like benefit product from the merchant. In addition, if no benefit is identified, the benefit engine may transmit a notification to the consumer consistent therewith, and which may further include an offer for a relevant benefit product from one or more additional merchants. In this manner, the consumer is informed of the benefits associated with his/her payment account(s), thereby enabling the consumer to avoid purchasing a duplicative benefit product (at the time of a payment account transaction) when such benefit is already in place and/or to purchase a benefit product from one or more available providers when such benefit is desired and currently lacking.

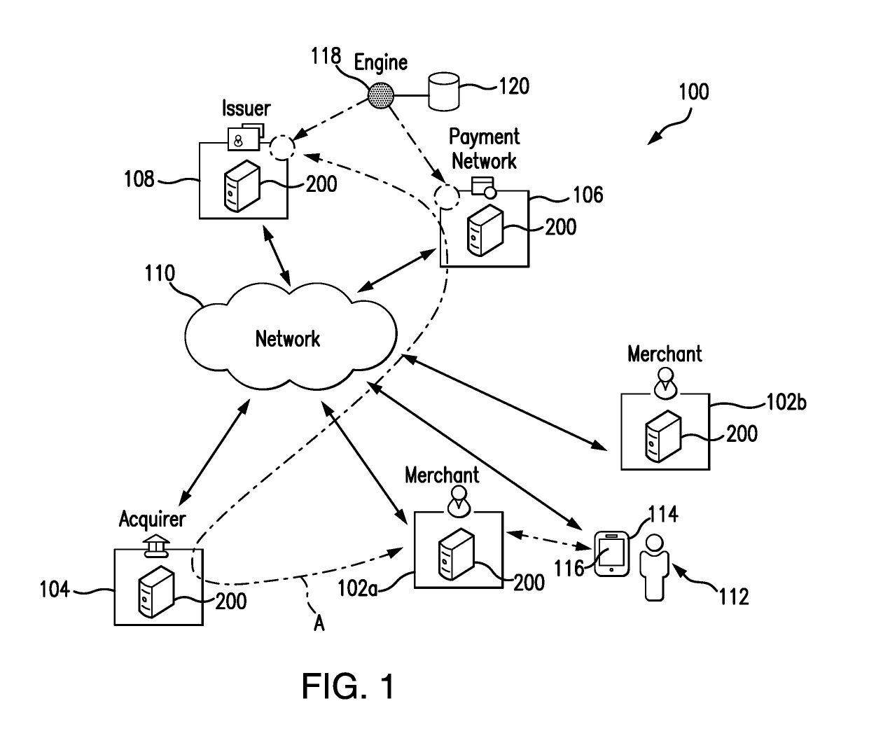

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, particular benefits available to payment accounts, inclusion of benefit providers, processing of payment account transactions, etc.

The system 100 generally includes merchants 102a-b, an acquirer 104 associated with the merchants 102a-b, a payment network 106, and an issuer 108 configured to issue payment accounts to consumers, each coupled to, and in communication with and/or with access to, network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts or users illustrated in FIG. 1, or any combination thereof. For example, network 110 may include multiple different networks, such as a private payment network made accessible by the payment network 106 to the acquirer 104 and the issuer 108, and, separately, a public network (e.g., the Internet, etc.), which may be accessible to consumers (e.g., consumer 112, etc.) for use in initiating payment account transactions at the merchants 102a-b, etc.

In the system 100, the merchant 102a offers various products for sale to consumers, such as consumer 112. In particular, the merchant 102a may offer products for sale through a physical, brick-and-mortar location or through a virtual storefront such as, for example, a merchant website. Example products may include, without limitation, hotel rooms, airline flights, rental cars, consumer electronics, travel insurance, roadside services, extended warrantees, etc. Similarly, the merchant 102b is a benefit product merchant, which offers for sale to consumers (including the consumer 112) benefit products such as, for example, travel insurance, roadside assistance services, extended warranties, etc. While the merchant 102b is described herein as offering for sale, and selling, benefit products, the merchant 102b may further offer other products for sale. In addition, it should be appreciated that a variety of different products may be offered for sale and sold by the merchants 102a-b, and by various other merchants (not shown), which are the same, different, or additional to the exemplary products listed above.

The consumer 112 in the system 100 is associated with a payment account, which may be used to fund purchases with merchants, including the merchants 102a-b. In the illustrated embodiment, the payment account is issued to the consumer 112 by the issuer 108 (however, this is not required in all embodiments), and is associated with a payment device (e.g., a payment card, a fob, a payment application, etc.). The consumer 112 is also associated with a communication device 114 (e.g., a smartphone, a tablet, etc.). In the illustrated embodiment, the communication device 114 includes an application 116 configured (e.g., via executable instructions, etc.) to perform certain of the operations described herein (e.g., receive and/or display benefit notifications, display and/or offer products for sale, etc.). In some aspects of the system 100, the application 116 may include (or be associated with) an electronic wallet (or e-wallet) payment application (e.g., a virtual wallet application such as, without limitation, MasterPass®, Apple Pay®, Android Pay™, Samsung Pay®, PayPal®, Google Wallet®, etc.) that configures the communication device 114 to act as a payment device for and/or with the consumer's payment account (which is stored in and/or associated with the e-wallet application) and potentially other payment accounts associated with the consumer 112. In other aspects of the system 100, however, the application 116 is (or may include) a non-payment application. Further, in other embodiments, the application 116 may be omitted, whereby the operations described herein rely on conventional aspects of the communication device 114 (e.g., short-message-service (SMS) messaging, etc.).

In an example transaction in the system 100, when the consumer 112 desires to make a purchase at the merchant 102a, for example, funded by the payment account (i.e., a payment account transaction), the consumer 112 presents payment account credentials to the merchant 102a. This may be done via a payment card (or other payment device) associated with the payment account, or via the e-wallet payment application in communication device 114, etc. With that said, it should be appreciated that the transaction may be initiated between the consumer 112 and the merchant 102a in various different manners, with or without use of the communication device 114 and the associated application 116.

In turn in the example transaction, the merchant 102a reads/receives the payment account credentials for the consumer's payment account. The merchant 102a then causes an authorization request, for the transaction, to be transmitted to the acquirer 104, along path A in the system 100. Upon receipt, the acquirer 104 communicates the authorization request with the issuer 108 through the payment network 106, such as, for example, through the network operated by Mastercard International Incorporated, the assignee of the present disclosure. The issuer 108 determines whether the consumer's payment account is in good standing and whether there are sufficient funds and/or credit to fund the transaction. If approved, an authorization reply, or response (indicating the approval of the transaction), is transmitted back from the issuer 108 to the merchant 102 again along path A, thereby permitting the merchant 102 to complete the transaction. The transaction is later cleared and/or settled (via appropriate transaction messages such as clearing messages and/or settlement messages, for example) by and between the merchant 102, the acquirer 104, and the issuer 108 (by appropriate agreements). If the transaction is declined, however, an authorization reply (indicating the decline of the transaction) is provided back to the merchant 102, thereby permitting the merchant 102 to halt or terminate the transaction, or request alternate funding.

In addition to the above, the merchant 102a, when appropriate for the product being purchased in the example transaction, offers the consumer 112 a benefit product, such as, for example, insurance, warranties, etc., in connection with the transaction. If the consumer 112 accepts the benefit product (i.e., desires to also purchase the benefit product), the amount of the transaction for the product is altered to account for the amount of the benefit product (and the transaction proceeds as described above). If the consumer declines, however, the transaction for the product proceeds without the amount of the transaction being altered.

Transaction data is generated, collected, and stored as part of the above interactions among the merchant 102, the acquirer 104, the payment network 106, the issuer 108, and the consumer 112. The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Additionally, or alternatively, transaction data may be transmitted among parts of the system 100 as desired and/or necessary. As used herein, transaction data may include, for example (and without limitation), primary account numbers (PANs) for accounts involved in the transactions, amounts of the transactions, merchant IDs for merchants involved in the transactions, merchant category codes (MCCs), dates/times of the transactions, etc. It should be appreciated that more or less information related to transactions, as part of either authorization or clearing and/or settling, may be included in transaction records (comprising transaction data) and stored within the system 100, at the merchant 102, the acquirer 104, the payment network 106 and/or the issuer 108.

In various exemplary embodiments, consumers (e.g., consumer 112, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions herein, subsequently for one or more of the different purposes described herein.

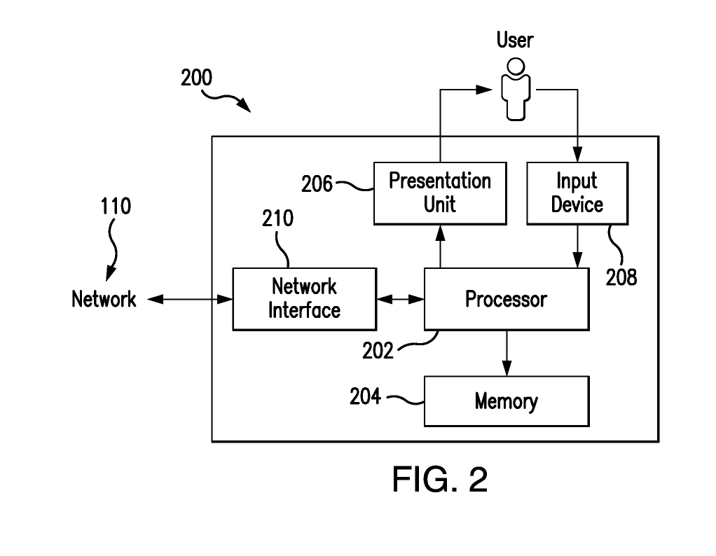

FIG. 2 illustrates exemplary computing device 200 used in the system 100.

The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are configured to function as described herein. In the system 100, each of the merchants 102a-b, the acquirer 104, the payment network 106, and the issuer 108 are illustrated as including, or being implemented in, a computing device 200, coupled to the network 110. Further, the communication device 114 associated with the consumer 112 may be considered a computing device, consistent with computing device 200. However, the system 100 should not be considered to be limited to the computing device 200, as described below, as different computing devices and/or arrangements of computing devices may be used.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, benefit profiles (e.g., included in a benefit data structure, etc.), consumer profiles (e.g., included in a consumer data structure, etc.), and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., notifications of benefits, etc.), visually, for example, to a user of the computing device 200 such as, for example, consumer 112, and/or other users associated with payment accounts, etc. Various interfaces (e.g., as defined by network-based applications, etc.) may be displayed at computing device 200, and in particular at presentation unit 206, to display and/or solicit certain information, as described herein. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user (i.e., user inputs) such as, for example, selections of benefit products, etc. The input device 208 is coupled to (and is in communication with) the processor 202 and may include, for example, one or more of a keyboard, a pointing device, a mouse, a stylus, a card reader, a camera, a touch sensitive panel (e.g., a touch pad or a touch screen, etc.), and/or other suitable input device. Further, in various exemplary embodiments, a touch screen may behave as both a presentation unit and an input device.

Further, the illustrated computing device 200 includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces (e.g., including the network interface 210, etc.) incorporated into or with the processor 202.

Referring again to FIG. 1, the system 100 also includes a benefit engine 118, which is configured, often by executable instructions, to perform one or more of the operations described herein. The benefit engine 118 is illustrated in the system 100 as a standalone computing device (e.g., consistent with computing device 200, etc.), but may be incorporated (entirely or in part) into the payment network 106 and/or the issuer 108, as indicated by the dotted lines. It should be appreciated that the benefit engine 118 may be incorporated in other entities, either shown or not shown in FIG. 1, in other system embodiments.

The system 100 further includes a consumer data structure 120 coupled to, and in communication with, the benefit engine 118. The consumer data structure 120 includes multiple consumer profiles, each associated with at least one consumer and/or at least one payment account. In the illustrated embodiment, the benefit engine 118 is configured to manage the consumer data structure 120, and the consumer profiles therein. This will be described more hereinafter.

In connection therewith, consumers (e.g., consumer 112, etc.) may register to the benefit engine 118, via interaction with various interfaces, for services as described herein. Through such interfaces, the benefit engine 118 solicits registration information from the consumers. In response, via the interfaces, the consumers are permitted to identify a payment account for registration (and identification of benefits) and a notification type for receiving correspondence regarding benefits. Once registration is complete, consumer profiles are compiled (based on the information received from the consumers via the interfaces) and stored in the consumer data structure 120. It should be appreciated that the notification type may include any desired notification type including, for example, SMS messaging, electronic mail (e-mail) messaging, and/or notification via an application (e.g., the application 116 at the communication device 114, etc.), etc. In addition, the notification type may be specific to a consumer and/or specific to different payment accounts within the consumer's profile. It should be appreciated that a consumer profile may include multiple payment accounts for a single consumer, and/or may further include multiple notification types for the consumer.

As part of registration, in various embodiments, the benefit engine 118 is configured to expose an application programming interface (API), called by issuer network applications and/or other applications (e.g., consumer applications, etc.), to facilitate the interaction between the consumers and the benefit engine 118. In response to the information provided by the consumers (e.g., via the API, etc.), the benefit engine 118 is configured to then compile consumer profiles for the consumers and store the consumer profiles in the consumer data structure 120. It should be appreciated that the API, or other interactions with the benefit engine 118, may also be provided to update and/or alter consumer profiles, as desired, after registration.

Apart from registering the consumers (and compiling the consumer profiles), the benefit engine 118 is configured to identify payment account transactions (e.g., via the payment network 106, the issuer 108, etc.) and determine, in association with a benefit data structure (not shown), whether payment accounts to which the identified transactions are directed include relevant benefits for the transactions (e.g., via another API associated with issuers of the payment accounts (e.g., issuer 108, etc.), etc.). Then, the benefit engine 118 is configured to notify the consumers, as appropriate, based on the consumer data structure 120, of the benefits (if any) associated with the implicated payment accounts and relevant to the identified payment account transactions. In some aspects of the system 100, the benefit engine 118 may be configured to identify the relevant benefits based on categories of merchants involved in the identified transactions, such as, for example, based on MCCs of the merchants, etc.

Additionally in the system 100, or alternatively, the benefit engine 118 is configured to notify the consumers that no benefits are associated with the payment accounts and relevant to the merchants involved in the identified transactions, when appropriate, and to further offer relevant benefit products to the consumers. For example, when the consumer 112 purchases a rental car from the merchant 102a (e.g., in the above example transaction, etc.), the benefit engine 118 may be configured to determine whether rental car insurance (broadly, a relevant benefit) is provided with/through the consumer's payment account. If such insurance is provided with the payment account, the benefit engine 118 is configured to notify the consumer 112 of the insurance benefit, thereby permitting the consumer 112 to avoid purchasing separate insurance through the merchant 102a (or through another entity). Alternatively in this example, if no such insurance is associated with (or provided through) the consumer's payment account, the benefit engine 118 may be configured to notify the consumer 112, and configured to further provide an offer for a rental car insurance product to the consumer 112 (broadly, a relevant benefit product) from other merchants (e.g., the merchant 102b, etc.), thereby allowing the other merchants to compete to provide the benefit product to the consumer.

Moreover, the benefit engine 118 is configured to compile data related to the determination of whether or not the payment accounts (involved in the identified transactions) are associated with relevant benefits, any offers for benefits provided to the consumers, and any sales of benefit products by merchants. In connection therewith, the benefit engine 118 is configured to compile trends, based on the data, specific to one or more issuers and/or one or more categories of merchants. The benefit engine 118 may then be configured to notify certain ones of the issuers about the trends, for example, when related to benefits offered and not offered for payment accounts associated with the issuers. In at least one embodiment, the benefit engine 118 is configured to receive consumer comments related to certain benefits that are either associated with or not associated with their payment accounts, and to relay the comments to the appropriate issuers of the payment accounts (or to other issuers of other payment accounts).

For example, the benefit engine 118 may compile data indicating that all consumers initiating purchases at the merchant 102a for rental cars, utilizing payment accounts issued by the issuer 108, subsequently purchase rental car insurance from the merchant 102b. Upon identifying such trend, the benefit engine 118 may notify the issuer 108 of such trend, and potentially suggest the issuer 108 to add rental car insurance as a benefit for payment accounts issued by the issuer 108.

While the illustrated system 100 includes two merchants 102a-b, one acquirer 104, one payment network 106, one issuer 108, and one consumer 112, it should be appreciated that any desired number of these parts may be included in the system 100 in other embodiments.

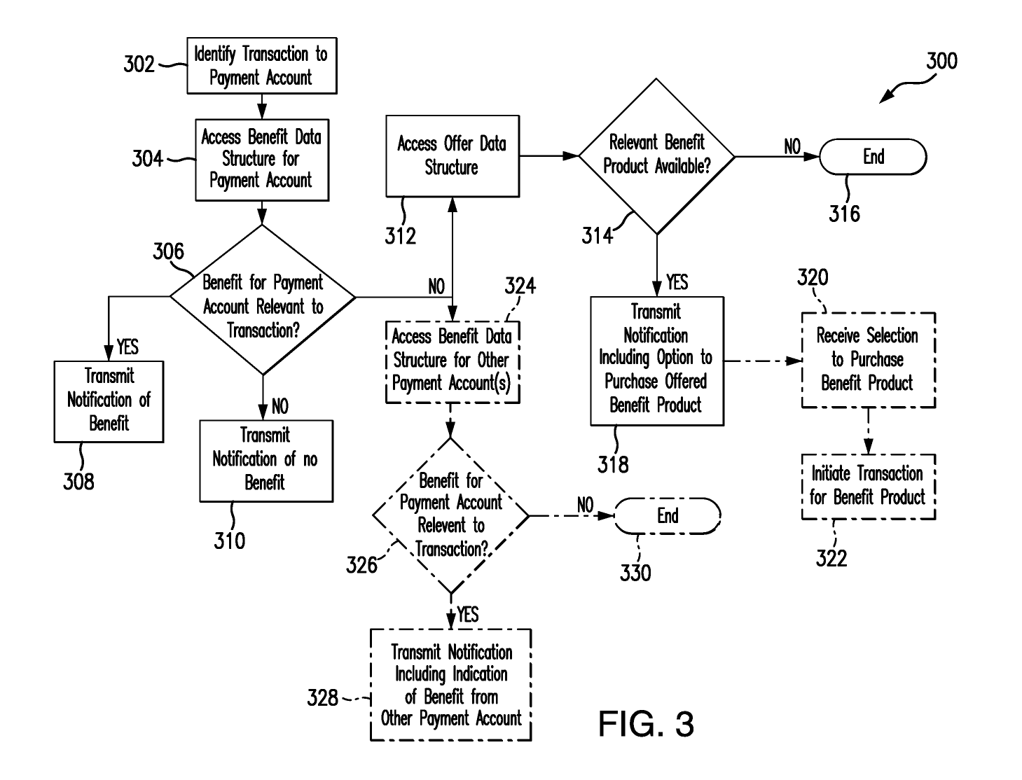

FIG. 3 illustrates an exemplary method 300 for notifying a consumer about a benefit associated with his/her payment account(s), in connection with initiating a payment account transaction at a merchant. The exemplary method 300 is described as implemented in the system 100 and, more particularly, in the benefit engine 118 therein. Further, for purposes of illustration, the exemplary method 300 is described with reference to other parts of the system 100 and to the computing device 200. Nonetheless, it should be understood that the methods herein are not limited to the exemplary system 100, or the exemplary computing device 200, and similarly, the systems and the computing devices herein are not limited to the exemplary method 300.

As described above in connection with the system 100, the consumer 112 is registered to the benefit engine 118, for example, when desired to receive one or more services as described herein (e.g., as part of onboarding, etc.). As such, the consumer 112 includes a consumer profile stored in the consumer data structure 120. The consumer profile identifies the consumer 112, and includes the consumer's payment account provided by the issuer 108 (e.g., a PAN for the consumer's payment account, a token for the consumer's payment account, etc.), as well as other ones of the consumers payment accounts provided by other issuers.

As shown in FIG. 3, at 302 in the method 300, the benefit engine 118 initially identifies a payment account transaction involving the consumer 112 and the merchant 102a. As part of identifying the transaction, the benefit engine 118 may identify all transactions (e.g., all authorization requests for transactions, etc.), for example, at the payment network 106, or only transactions for which a consumer profile is included in the consumer data structure 120 (e.g., based on the consumer's name, the PAN for the consumer's payment account, etc. as included in the authorization request; etc.). For example, upon identifying a payment account transaction, the benefit engine 118 may determine a name of the consumer 112 involved in the transaction and search in the consumer data structure 120 for the consumer's name. In so doing in this example, when the benefit engine 118 finds the consumer's name in the consumer data structure 120, the benefit engine 118 determines that the consumer 112 is registered and retrieves the consumer's profile.

Once the transaction is identified (and the consumer 112 involved in the transaction is identified as being registered), the benefit engine 118 accesses the benefit data structure, at 304, and determines whether a relevant benefit is associated with the payment account used in the transaction, at 306. A relevant benefit may include, for example, a benefit associated with the consumer's payment account that is particularly relevant to the identified transaction and, potentially, a product identified in the transaction. Examples of such relevant benefits include, without limitation, travel insurance and/or luggage insurance and/or trip interruption insurance for travel booked and funded through the consumer's payment account (e.g., related to vacations, leisure travel, business travel, etc.), roadside assistance service and/or rental car insurance for vehicles rented using the payment account, extended warranties for products purchased using the payment account, price protection insurance for products (e.g., televisions, computers, washing machines, etc.) purchased using the payment account, etc.

As an example, in connection with determining if a relevant benefit is associated with the identified transaction (e.g., at 306 in the method 300, etc.), the benefit engine 118 may retrieve a benefit summary for the consumer's payment account from the benefit data structure (e.g., from the consumer's profile, etc.), or the benefit engine 118 may identify the issuer 108 as associated with the consumer's payment account (used in the transaction) and call an API associated with the issuer 108 to request a benefit summary for the consumer's payment account (broadly, to access a benefit data structure). In either case, the benefit engine 118 may then determine, based on an MCC associated with the merchant 102a, whether any of the benefits in the benefit summary are relevant. It should be appreciated that beyond MCC, other factors of the identified transaction (e.g., product type, product category, card present transition, transaction location, etc.), other factors related to the merchant 102a involved in the transaction (e.g., merchant industry, etc.) and/or other factors related to the consumer 112 may be employed to determine relevance of a benefit to the transaction. For example, when the benefit engine 118 identifies a transaction for the consumer 112 involving a television (purchased from the merchant 102a), the benefit engine 118 may identify (e.g., at 306 in the method 300, etc.) that the consumer has the following benefits for his/her payment account in connection with the transaction (e.g., based on the product being a television, based on the product being an electronic device, etc.): price protection insurance for ninety days from the purchase data, and an extended warranty for one additional year after expiration of the manufacturer's warranty.

When a relevant benefit is found (at 306), the benefit engine 118 causes a notification to be provided to the consumer 112, at 308, identifying the benefit. In particular, the benefit engine 118 identifies the preferred mode of communication for the consumer 112, based on the consumer profile, and then transmits the notification thereby. The notification may be transmitted to the consumer 112 in real time or near real time. For example, the consumer 112 may receive the notification substantially immediately upon approval of the authorization request, by the issuer 108, for the payment account transaction (or when the authorization reply approving the transaction is received by the payment network 106 from the issuer 108 (potentially depending on location of the benefit engine 118 in the system 100)).

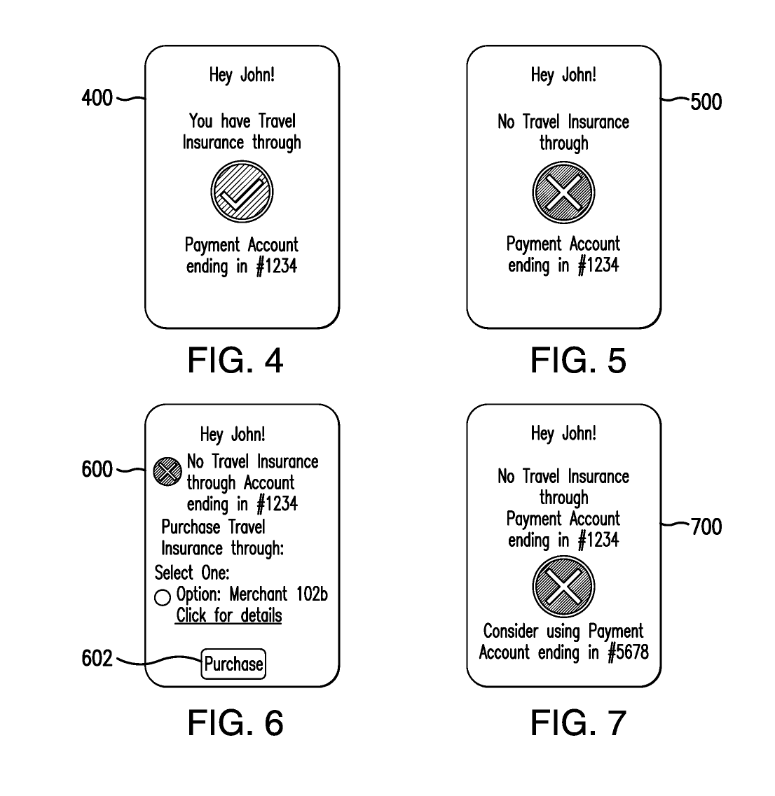

As an example, the benefit engine 118 may transmit the notification (identifying the benefit) to the consumer 112 via the application 116 at the consumer's communication device 114 upon approval of the authorization request for the payment account transaction, which upon receipt causes the notification to display to the consumer 112 (e.g., via presentation unit 206, etc.). In connection therewith, FIG. 4 illustrates an example notification interface 400 that may be displayed to the consumer 112 via the application 116. As shown, in the interface 400, the benefit includes travel insurance provided by/through the consumer's payment account ending in #1234. As another example, the benefit engine 118 may transmit the notification to the consumer 112 via a SMS message (based on the notification type indicated in the consumer profile). As still another example, the benefit engine 118 may transmit the notification to the consumer 112 via an e-mail.

With continued reference to FIG. 3, when no relevant benefit is found for the payment account in connection with the identified transaction (at 306), the benefit engine 118 causes a notification to be provided to the consumer 112, at 310, indicating that no benefit was found. In connection therewith, FIG. 5 illustrates an example notification interface 500 that may be displayed to the consumer 112 via the application 116, for example, in which the consumer 112 is informed that no benefit (i.e., no travel insurance) is available for the identified transaction by/through the consumer's payment account ending in #1234. Again, the notification may be transmitted to the consumer 112 in real time or near real time.

In addition when no relevant benefit is found (at 306), the benefit engine 118 accesses an offer data structure, at 312, and searches for relevant benefit products offered by one or more other merchants (e.g., by the merchant 102b, etc.), at 314. In particular, the benefit engine 118 searches for corresponding benefit products to provide/offer to the consumer 112 in connection with the transaction, for purchase, since a corresponding benefit is not available through the consumer's payment account. When a corresponding benefit product is not identified in the offer data structure, the method ends, at 316. Alternatively, when a corresponding benefit product is identified in the offer data structure (at 314), the benefit engine 118 transmits a notification to the consumer 112, at 318, with an option for the consumer to purchase the benefit product. In so doing, and as described above, the benefit engine 118 identifies the preferred mode of communication for the consumer 112, based on the consumer profile, and then transmits the notification thereby. FIG. 6 illustrates an example notification interface 600 that may be displayed to the consumer 112 via the application 116, for example, in which the consumer 112 is informed that no benefit (i.e., no travel insurance) is available for the identified transaction by/through the consumer's payment account ending in #1234. However, the interface 600 includes an offer for a corresponding benefit product for sale to the consumer 112 through another merchant (i.e., merchant 102b), which can then be purchased via button 602 as desired. The notification may again be transmitted to the consumer 112 in real time or near real time.

Optionally in the method 300, as indicated by the dotted lines in FIG. 3, when the benefit engine 118 receives a selection by the consumer 112 to purchase the offered benefit product, at 320 (e.g., via purchase button 602 in the notification interface 600, etc.), in response to the notification (transmitted at 318), the benefit engine 118 may initiate a transaction for the offered benefit product, at 322. For example, the benefit engine 118 may generate a new transaction (and authorization request) for the benefit product and communicate the transaction to the issuer 108, for example, via the payment network 106 (in a similar manner to that described above in the system 100). In connection therewith, reference to the original product being purchased (which triggered the offer for the benefit product) and/or the transaction for such product may be referenced in the new transaction (and authorization request) for the benefit product. Or, the benefit engine 118 may append an amount of the benefit product to the amount of the identified transaction, and the underlying transaction then proceeds as described above.

Further, when no relevant benefit is found (at 306), the benefit engine 118 may optionally (as again indicated by the dotted lines in FIG. 3), access the benefit data structure, at 324, to determine whether another payment account in the consumer profile (i.e., another registered payment account of the consumer 112) is associated with a relevant benefit. In so doing, and similar to the above, the benefit engine 118 may retrieve a benefit summary for the consumer's other payment account(s) from the benefit data structure (or from the consumer profile), or the benefit engine 118 may identify the issuer(s) as associated with the consumer's other payment account(s) and call an API associated therewith to request a benefit summary for the payment account(s). In either case, the benefit engine 118 may then determine, again based on an MCC associated with the merchant 102a, whether any of the benefits in the benefit summary are relevant.

The benefit engine 118 then determines, at 326, whether a relevant benefit is associated with the other payment account(s). When a relevant benefit is found, the benefit engine 118 causes a notification to be provided to the consumer 112, at 328, identifying the benefit. In particular, the benefit engine 118 identifies the preferred mode of communication for the consumer 112, based on the consumer profile, and then transmits the notification thereby. FIG. 7 illustrates an example notification interface 700 that may be displayed to the consumer 112 via the application 116, for example, in which the consumer 112 is informed that no benefit (i.e., no travel insurance) is available for the identified transaction by/through the consumer's payment account ending in #1234, but that another one of the consumer's payment accounts, i.e., the account ending in #5678, does include a benefit relevant to the transaction. In this manner, the consumer 112 is able to potentially pay with the alternate payment account, so that the relevant benefit associated with that payment account can be utilized in connection with the underlying transaction. Further, it is contemplated that if payment for the product is split between different payment accounts, with one payment account having the desired benefit, only a prorated portion of the desired benefit may be applicable.

However, when no relevant benefit is found for the other payment account(s) (at 326), the benefit engine 118 ends the method, at 330.

In some aspects of the method 300, the benefit engine 118 may compile, in a data structure, data related to the determination (performed at 306) of whether a relevant benefit is associated with the consumer's payment account used in the transaction (along with data related to other determinations performed by the benefit engine 118 for other transactions). In so doing, the benefit engine 118 may identify trends specific to the issuer 108, and potentially other issuers, about use (or non-use) of the benefits associated with payment accounts they provide and potential new benefits to be added to the payment accounts (based on purchase volumes of relevant benefit products from other providers to supplement benefits not offered by the issuer 108, for example). The benefit engine 118 may then notify the issuer 108 regarding the trends offered for payment accounts associated with the issuers.

In some aspects of the method 300, the benefit engine 118 may also receive comments from the consumer 112, and potentially other consumers, related to certain benefits that are either associated with or not associated with their payment accounts. For example, the consumer 112 may provide comments regarding a lack of certain benefits (which the consumer must instead purchase from other providers), or non-use of certain benefits associated with his/her payment account (e.g., benefits that are provided by rarely or never used, etc.). In turn, the benefit engine 118 may relay the comments to the issuer 108, so that the issuer 108 can contemplate adding one or more benefits based on the consumer's request(s).

In view of the above, the systems and methods herein notify consumers about various relevant benefits associated with their payment accounts when the consumers use the payment accounts to purchase products (i.e., benefits relevant to the products being purchased). In so doing, the consumers are made aware of relevant benefits already provided through their payment accounts, so duplicate benefits are not purchased. In addition, the consumers are also made aware of a lack of such relevant benefits (as lacking through their payment accounts), so that, if desired, benefits can be purchased through alternative merchants. Further, when desired benefits are lacking through the consumers' payment accounts, the systems and methods herein may provide options to the consumers to purchase the desired benefits from different merchants. In this manner, the systems and methods herein may enable consumers to be better informed about various benefits associated with their payment accounts, in connection with purchase transactions for products using such payment accounts.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) identifying a transaction to a payment account, the transaction involving a merchant; (b) accessing a benefit data structure for the payment account; (c) determining, by the computing device, whether a relevant benefit is included in the benefit data structure for the payment account; (d) transmitting a notification to the consumer regarding the relevant benefit, in connection with the identified transaction, whereby the consumer is permitted to avoid purchasing a benefit product from the merchant, which is at least partially duplicative of the relevant benefit; (e) when no relevant benefit is identified in the benefit data structure: (i) identifying, in an offer data structure, at least one relevant benefit product for the transaction; (ii) receiving a selection of an option to purchase the identified at least one relevant benefit product; and (iii) initiating a transaction for the identified at least one relevant benefit product; and/or (f) when no relevant benefit is identified in the benefit data structure for the payment account: (i) determining whether a relevant benefit is included in the benefit data structure for a different payment account of the consumer; and (ii) when the relevant benefit is identified in the benefit data structure for the different payment account, appending an indication of the relevant benefit being associated with the different payment account to a notification, prior to transmitting the notification to the consumer.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in informing a consumer about one or more benefits associated with a payment account, the method comprising:
identifying, at a computing device, a transaction to a payment account, the transaction involving a merchant;
accessing, by the computing device, a benefit data structure for the payment account;
determining, by the computing device, whether a relevant benefit is included in the benefit data structure for the payment account; and
transmitting, by the computing device, a notification to the consumer regarding the relevant benefit, in connection with the identified transaction, whereby the consumer is permitted to avoid purchasing a benefit product from the merchant, which is at least partially duplicative of the relevant benefit.

2. The computer-implement method of claim 1, wherein determining whether a relevant benefit is within the benefit data structure for the payment account includes searching based on a category of the merchant in the benefit data structure.

3. The computer-implemented method of claim 2, wherein searching based on the category of the merchant includes searching, in the benefit data structure, based on at least one merchant category code (MCC) for the merchant.

4. The computer-implemented method of claim 1, wherein determining whether a relevant benefit is within the benefit data structure for the payment account includes search based on a product associated with the transaction in the benefit data structure.

5. The computer-implement method of claim 1, further comprising, when no relevant benefit is identified in the benefit data structure, identifying, in an offer data structure, at least one relevant benefit product for the transaction; and
wherein the notification includes an option to purchase the identified at least one relevant benefit product.

6. The computer-implemented method of claim 5, wherein the merchant is associated with a category represented by a merchant category code (MCC); and
wherein identifying the at least one relevant benefit product includes identifying the at least one relevant benefit product based on the MCC associated with the merchant.

7. The computer-implemented method of claim 5, further comprising receiving, at the computing device, a selection of the option to purchase the identified at least one relevant benefit product; and
initiating a transaction for the identified at least one relevant benefit product.

8. The computer-implemented method of claim 1, wherein the notification to the consumer includes a summary of the relevant benefit.

9. The computer-implemented method of claim 1, wherein accessing the benefit data structure includes calling an application programming interface (API) associated with an issuer of the payment account.

10. The computer-implemented method of claim 1, further comprising:
when no relevant benefit is identified in the benefit data structure for the payment account, determining, by the computing device, whether a relevant benefit is included in the benefit data structure for a different payment account of the consumer; and
when the relevant benefit is identified in the benefit data structure for the different payment account, appending, by the computing device, an indication of the relevant benefit being associated with the different payment account to the notification, prior to transmitting the notification to the consumer.

11. A system for use in informing consumers regarding benefits, associated with payment accounts, in connection with payment account transactions by the consumers, the system comprising:
a consumer data structure including multiple consumer profiles, each consumer profile including a payment account; and
a benefit engine coupled to the consumer data structure and configured to:
identify a transaction to a payment account of one of the multiple consumer profiles, the transaction involving a merchant;
determine whether the payment account is associated with a relevant benefit based on a category of the merchant and/or a product included in the transaction; and
when a relevant benefit is associated with the payment account, transmit a notification to a consumer associated with the payment account consistent with the one of the multiple consumer profiles associated with the consumer, whereby the consumer is informed of the relevant benefit in connection with the transaction.

12. The system of claim 11, wherein each of the consumer profiles in the consumer data structure includes a notification type; and
wherein the benefit engine is configured to transmit the notification to the consumer consistent with the notification type of the one of the multiple consumer profiles associated with the consumer.

13. The system of claim 11, wherein the merchant is associated with a category represented by a merchant category code (MCC); and
wherein the benefit engine is configured, in connection with determining whether the payment account is associated with a relevant benefit, to identify the relevant benefit based on the MCC associated with the merchant.

14. The system of claim 11, wherein the benefit engine is configured, in connection with determining whether the payment account is associated with a relevant benefit, to identify the relevant benefit based on a type of the product included in the transaction.

15. The system of claim 11, wherein the benefit engine is further configured, when no relevant benefit is determined, to identify at least one relevant benefit product for the transaction from an offer data structure; and
wherein the notification includes an option to purchase the identified at least one relevant benefit product.

16. The system of claim 15, wherein the benefit engine is further configured to:
receive a selection of the option to purchase the identified at least one relevant benefit product; and
initiate a transaction for the identified at least one relevant benefit product.

17. The system of claim 11, wherein the one of the multiple consumer profiles associated with the consumer includes at least one different payment account; and
wherein the benefit engine is further configured to:
when no relevant benefit is determined, determine whether the at least one different payment account is associated with a relevant benefit; and
when the at least one different payment account is associated with a relevant benefit, append an indication of the relevant benefit being associated with the at least one different payment account to the notification, prior to transmitting the notification to the consumer.

18. A non-transitory computer readable storage media including computer-executable instructions for use in identifying benefits associated with payment accounts in connection with purchase transactions by consumers to the payment accounts, which when executed by a processor, cause the processor to:
identify a transaction to a payment account;
determine, in a benefit data structure, whether the payment account is associated with a relevant benefit; and
when no relevant benefit is associated with the payment account, identify at least one relevant benefit product for the transaction from an offer data structure and initiate a payment account transaction for the at least one relevant benefit product.

19. The non-transitory computer readable storage media of claim 18, wherein the computer-executable instructions, when executed by the processor, further cause the processor to, when a relevant benefit is associated with the payment account, transmit a notification to the consumer associated with the payment account consistent with a consumer profile for the consumer.

20. The non-transitory computer readable storage media of claim 19, wherein the computer-executable instructions, when executed by the processor, further cause the processor to, when no relevant benefit is associated with the payment account, determine whether at least one different payment account included in the consumer profile for the consumer is associated with a relevant benefit, prior to identifying the at least one relevant benefit product for the transaction from the offer data structure, whereby the consumer is permitted to avoid purchasing the at least one relevant benefit product when it is at least partially duplicative of the relevant benefit associated with the at least one different payment account included in the consumer profile.
